(19) United States
(12) Patent Application Publication
(10) Pub. No.: US 2019/0307123 A1
(43) Pub. Date: Oct. 10, 2019

(54) KIT OF ATTRACTANTS FOR ATTRACTING THE COFFEE BERRY BORER

(71) Applicant: INSTITUT NATIONAL DE LA RECHERCHE AGRONOMIQUE, PARIS (FR)

(72) Inventors: BRIGITTE FREROT, FONTENAY LE FLEURY (FR); STÉPHANE DESQUILBET, RENNES (FR)

(21) Appl. No.: 16/466,660

(22) PCT Filed: Dec. 1, 2017
(86) PCT No.: PCT/FR2017/053341

§ 371 Date: Jun. 5, 2019

(30) Foreign Application Priority Data
Dec. 6, 2016 (FR) 1662023

(51) Int. Cl. A01N 31/02

(52) U.S. Cl. CPC A01N 31/02; A01N 27/00

(57) ABSTRACT

The present invention relates to a kit of attractants for attracting the coffee berry borer, Hypothenemus hampei, comprising a mixture of ethanol/methanol and (−) limonene and/or 2-ethylhexanol, as well as to the uses thereof and methods employing said kit.

### FIELD OF THE INVENTION

The present invention relates to an attracting composition and also to the use thereof in the trapping of the coffee berry borer, Hypothenemus hampei.

### TECHNICAL BACKGROUND OF THE INVENTION

The coffee berry borer, Hypothenemus hampei (Ferrari), is the most devastating insect pest for coffee tree crops. Originating in Africa, the coffee berry borer has colonized almost all the coffee-producing regions of the world (with the exception of a few islands), and has withstood eradication programs. This insect pest, on the one hand, causes significant losses (up to 90% of cherries infested in untreated plantations) and, on the other hand, affects the quality of the beans.

The cryptogamic lifestyle of the insect and the appearance of resistances make chemical treatments poorly effective in controlling this insect pest. Furthermore, agricultural policies have a tendency to favor solutions that are alternatives to the use of pesticides. The search for methods of biological control against the coffee berry borer thus appears to be a major challenge for coffee producers.

In this context, several studies have been carried out since the 1990s and have demonstrated the attractiveness of the coffee cherry aromas on the borers. Moreover, mass trapping appears to be a promising method of biological control for controlling this insect pest. Indeed, the borers have a lifecycle that is dependent on coffee, reproduction being able to occur only in the cherries in which the coffee beans are already formed (100 to 150 days after flowering). After the harvest, a period begins during which the beans conducive to reproduction become rarer and the “colonizing” females must leave the foods that have become dry in search of new cherries during the subsequent fruiting. It is at the end of this survival phase that mass trapping would be the most relevant.

More particularly, studies have demonstrated the effectiveness of an ethanol/methanol mixture as an attractant for the mass trapping of coffee berry borers (see in particular A. Ortiz et al., Journal of Agricultural and Food Chemistry, Vol. 52, No. 19, 5914-5918, 2004). Nevertheless, the improvement of this attractant with good specificity for the coffee berry borer is of major interest for being able to further limit the infestation of coffee trees by coffee berry borers, and thus to increase coffee crop yields and quality.

### SUMMARY OF THE INVENTION

The inventors of the present application have succeeded in developing a more effective attractant, based on the addition of volatile organic compounds emitted by coffee beans and capable of intervening in the recognition of the host plants by the borers. More specifically, the inventors of the present application have discovered the advantage of adding, to the alcohol mixture used today, a molecule of the terpenoid class: (−)-limonene and/or a particular branched alcohol, 2-ethylhexanol. This discovery is particularly unexpected, insofar as 2-ethylhexanol is rarely emitted by plants and has been demonstrated for the first time by the applicants as a constituent of the volatile organic compounds emitted by coffee cherries. Likewise, while limonene was known as a constituent of coffee beans (E. Naptali et al., http://www.scielo.org.mx/pdf/jmcs/v57n4/v57n4a9.pdj), (−)-limonene has never been envisioned as an attractant of the borer, although several volatile organic compounds emitted by coffee cherries have been proposed for this purpose (B. P. Dufour et al., Colloque Scientifique International sur le Café [International Scientific Symposium on Coffee], ASIC, Vol. 24, 922-926, 2012).

Thus, the present invention relates to a kit of attractants for attracting the coffee berry borer Hypothenemus hampei, characterized in that it comprises a mixture of ethanol/methanol and (−)-limonene and/or 2-ethylhexanol.

The invention also relates to a device comprising the kit of attractants according to the invention, said device being capable of trapping and/or killing said borer.

Thus, the present invention relates to the use of the kit of attractants or the device according to the present invention, for attracting the coffee berry borer Hypothenemus hampei, preferably for trapping and/or killing said borer and for modifying the behavior of said borer.

It also relates to a method for attracting the coffee berry borer Hypothenemus hampei, in which the kit of attractants or the device according to the invention is placed in or in proximity to a site of attraction.

### DETAILED DESCRIPTION OF THE INVENTION

### Attractant Kit

According to a first aspect, the present invention relates to a kit of attractants for attracting the coffee berry borer Hypothenemus hampei, characterized in that it comprises a mixture of ethanol/methanol and (−)-limonene and/or 2-ethylhexanol.

The inventors of the present invention have discovered that, unexpectedly, the use of the limonene (−) enantiomer or of 2-ethylhexanol, or else of a mixture of the two, makes it possible to significantly improve the attractiveness of the ethanol/methanol mixture in the attraction of the coffee berry borer Hypothenemus hampei.

The coffee berry borer, Hypothenemus hampei, is also referred to as the coffee bean borer or the coffee cherry borer. The coffee berry borer is a coleoptera insect of the family Curculionidae, which feeds exclusively on coffee. It is present in almost all the crops throughout the world and virtually all of its lifecycle takes place in the fruits of the coffee tree, to the detriment of the bean.

The expression “kit of attractants for attracting the coffee berry borer” is intended to mean a kit capable of significantly increasing the number of borers in a site of attraction and interest, relative to a control situation without said kit of attractants. The kit of attractants thus serves as a “lure” or “bait” for the coffee berry borer. Preferably, this kit of attractants is specific to the coffee berry borer, that is to say that the attracting effect of the kit of attractants is preferentially exerted on coffee berry borers, preferably mainly on coffee berry borers, and even more preferably only on coffee berry borers.

The expression “kit of attractants” is intended to mean either a composition of attractants or several attractants used together. More particularly, the kit of attractants is suitable for dispensing said attractants in the environment, preferably by diffusion.

The expression “mixture of ethanol/methanol” is intended to mean a composition consisting of ethanol and methanol, preferably in the form of pure or essentially pure (i.e. more than 90, 95, 99 or 99.5% pure) alcohols.

The term “approximately” is intended to mean the value + or −10%, preferably + or −5% of said value. For example, approximately 100 means from 90 to 110, and preferably from 95 to 105.

The inventors have demonstrated that the use of the limonene (−) enantiomer and/or 2-ethylhexanol makes it possible to improve the attractiveness of said ethanol/methanol mixture to the coffee berry borer.

Since limonene is a chiral molecule, it has two enantiomers, that is to say two forms of optical isomers which correspond to two structures, which are images of one another in a symmetry relative to a plane, and the properties of which can differ. There are three types of nomenclature for differentiating enantiomers: R/S, D/L and +/−. The limonene (−) enantiomer is also known as L-limonene or S-limonene.

The limonene (−) enantiomer is in sufficient amount to significantly increase the attractiveness of the kit of attractants according to the invention. Preferably, the (−)-limonene is in purified form. Thus, it is in a form that is more than 90, 95, 99 or 99.5% pure.

In one particular embodiment, the kit of attractants of the invention, containing the ethanol/methanol mixture, and the (−)-limonene and/or the 2-ethylhexanol, also comprises a diluent. More particularly, said diluent is devoid of attracting activity toward said coffee berry borer. In particular, it can serve as a diffusion matrix for the attractants of the kit and can also influence the diffusion of said attractant in the environment. The diluent may be solid or liquid. The diluent may be an odorous fatty substance of waxes. It may for example be paraffin or a mineral oil. In one preferred embodiment, the diluent is paraffin.

In one additional embodiment, said kit of attractants comprising the mixture of ethanol/methanol and the (−)-limonene and/or the 2-ethylhexanol also comprises one or more additional attracting molecule(s). In one particular embodiment, said additional attracting molecule(s) are volatile organic compounds. The expression “volatile organic compound” is intended to mean any organic compound that can readily be found in gas form in the atmosphere and that is capable of propagating over a greater or lesser distance from its site of emission. Preferably, said volatile organic compound is emitted by the coffee cherries. Those skilled in the art will be able to select the additional attracting molecules which are not detrimental to the attracting effect of the (−)-limonene and/or the 2-ethylhexanol.

In one preferred embodiment, said additional attracting molecule(s) are kairomones, in particular of coffee beans or cherries. The term “kairomone” is intended to mean any substance produced by an emitting living being (for example coffee beans) which, when it is released into the environment, triggers a behavioral response in another species (receiver), in this case the coffee berry borer, Hypothenemus hampei. Kairomones are beneficial to the receiver. Kairomones are capable of intervening in the recognition of host plants by the borers.

In one particular embodiment, the additional attracting molecule(s) is selected from the group consisting of: 2,4,6-cycloheptatrien-1-one, 2,6-bis(1,1-dimethylethyl)-4-(1-oxopropyl)phenol, 2-methoxy-3-(1-methylpropyl)pyrazine, 2-methoxy-3-(2-methylpropyl)pyrazine, (2E)-tridecenyl acetate, (5R,7S)-conophthorin, (5S,7S)-conophthorin, (E)-4,8-dimethylnona-1,3,7-triene, (E)-dendrolasin, [1,1′-bicyclopentyl]-2-one, 1,1-dimethylcyclopropane, 1-butanol, 1-ethoxy-2-propanol, 1-hexanol, 1-hexen-3-ol, 1-methoxy-2-propanol, 1-methoxy-3-methylbenzene, 1-methoxy-4-methylbenzene, 1-methylethyl benzoate, 1-methylethyl hexadecanoate, 1-nonanol, 1-nonene, 1-nonen-4-ol, 1-octen-3-ol, 1-pentanol, 1-phenoxypropan-2-ol, 1-propanol, 1-terpineol, 2-(E)-hexenal, 2-(E)-hexenol, 2-(E)-octenal, 2-(E)-pentenal, 2-(Z)-pentenol, 2,2-dimethylpropanal, 2,3-butanediol, 2,6-di-tert-butylquinone, 2,6-dimethyl-7-octenol, 2-butenal, 2-butyl-1-octanol, 2-carene, 2-cyclohepten-1-one, 2-ethyl-1-hexyl acetate, 2-ethylhexanal, 2-heptanol, 2-heptanone, 2-heptyl acetate, 2-indanol, 2-methoxy-3-methylpyrazine, 2-methyl isobutyrate, 2-methyl-1,3-butadiene, 2-methyl-1-propanol, 2-methyl-2-butenal, 2-methyl-3-pentanol, 2-methylbutanol, 2-methylethyl propanoate, 2-methylfuran, 2-methylpropanal, 2-methylpropyl acetate, 2-methoxy-3-(2-ethylpropyl)pyrazine, 2-nonanone, 2-pentanol, 2-pentanone, 2-pentyl acetate, 2-phenoxyethanol, 2-propanone, 3-(1-methylethyl)-2-methoxypyrazine, 3-(Z)-hexenol, 3,4-dimethylpentanol, 3,7-dimethyl-1,3,7-octatriene, 3-ethyl-4-methylpentanol, 3-heptanone, 3-hexen-1-ol formate, 3-hydroxy-2-butanone, 3-isobutyl-(2-methylpropyl)-2-methoxypyrazine, 3-methyl-1-butanal, 3-methyl-1-butanol, 3-methyl-1-butanol acetate, 3-methyl-2-butanone, 3-methyl-3-butenol, 3-methylbutanol acetate, 3-methylfuran, 3-octanol, 3-octanone, 3-pentanone, 3-sec-butyl-2-methoxypyrazine, 4,7-dimethyl-4-octanol, 4,8-dimethyl-3,7-nonadien-2-ol, 4-hydroxy-4-methylpentan-2-one, 4-terpineol, 5-methyl-1-heptene, 6-ethenyldihydro-2,2,6-trimethyl-2H-pyran-3(4H)-one, 6-methyl-5-hepten-2-one, acetaldehyde, acetic acid, hexanoic acid, hexadecenoic acid, acora-3,5-diene, alloaromandrene, anisole, benzaldehyde, benzyl alcohol, borneol, bourbonene, brocain (=1,6-dioxaspiro[4,5]decane), butyl acetate, butyl butanoate, C2-benzene, C3-benzene, camphene, camphenilone, carboxylic acid, caryophyllene, caryophyllene oxide, chalcogran (=2-ethyl-1,6-dioxaspiro[4.4]nonane), cis-calamenene, cis-linalool oxide, cumene, curcumene, cymene, decanal, anethofuran (Cas No. 74410-10-9), dimethyl disulfide, dimethylpropanedioic acid, dodecanal, elixene, ethanol, ethyl acetate, propanoic acid ethyl ester, ethyl isobutyrate, ethyl isovalerate, ethyl salicylate, ethylbenzene, ethylbenzene ester, frontalin (=1,5-dimethyl-6,8-dioxabicyclo[3.2.1]octane), geranial, geranylacetone, hexahydrofarnesyl acetone, hexanal, hexanol, humulene, humulene epoxide, isobutyl acetate, isobutyl butyrate, isopentanol, isopentyl acetate, kaurene, limonene, limonene oxide, linalool, linalool oxide, longiborneol, longiborneol acetate, longifolene, m-cymene, menthol, menthone, mesitylene, methyl-2-hydroxy-6-methylbenzoate, methyl acetate, methyl hexanoate, methyl salicylate, methyl-2-hydroxybenzoate, methyl-3-ethyl-4-methyl pentanoate, methylcyclohexane, m-methylanisol, myrcene, naphthalene, neral, nonanal, nonane, nonene, octanal, octane, octyl methanoate, oleyl alcohol, o-xylene, p-1,3,8-menthatrienol, p-1,3,8-menthatriene, para-xylene, p-cymene, pentanal, pentyl acetate, phenylethyl alcohol, prezizaene, propyl acetate, p-tert-butylbenzyl alcohol, pulegone, sabinene, sativene, styrene, thujene, thujone, thujopsene, toluene, trans-linolool oxide, trans-pyranlinool oxide, trans-β-ocimene, undecanal, undecane, α-bergamotene, α-cedrene, α-chamigrene, α-copaene, α-fenchocamphorone, α-isomenthone, α-longipinene, longipinene, α-muurolene, α-neocallitropsene, α-phellandrene, α-pinene, α-terpinene, α-terpinolene, β-acoradiene, β-cedrene, β-elemene, β-gurjunene, β-himachalene, β-phellandrene, β-pinene, γ-butyrolactone, γ-eudesmol, γ-muurolene, δ-cadinene and δ-germacrene.

More preferentially, said kit of attractants comprising a mixture of ethanol/methanol and of (−)-limonene and/or of 2-ethylhexanol also comprises one or more additional attracting molecule(s) selected from the group consisting of: 1-octen-3-ol, 2-heptanol, 2-heptanone, 2-indanol, 2-phenylethanol, 3-ethyl-4-methylpentanol, 6-methyl-5-hepten-2-one, ethylbenzene acetate, butyl acetate, isobutyl acetate, phenylethyl alcohol, benzaldehyde, brocain, caryophyllene, chalcogran, conophthorin, ethylbenzene, frontalin, humulene (also called α-caryophyllene), kaurene, linalool, longiborneol, longipinene, methylcyclohexane, myrcene, nonane, limonene oxide, linalool oxide, ethyl salicylate, methyl salicylate, α-copaene, α-pinene et β-pinene.

Even more preferably, said kit of attractants comprising a mixture of ethanol/methanol and/or (−)-limonene and/or of 2-ethylhexanol also comprises one or more additional attracting molecule(s) selected from the group consisting of: α-pinene, 3-pinene, caryophyllene, myrcene, 3-ethyl-4-methylpentanol, 2-heptanone, methyl salicylate, benzaldehyde and ethylbenzene.

### Amounts, Proportions and Ratios

According to one embodiment, the kit of attractants according to the invention comprises an amount by weight of the ethanol/methanol mixture of between 0.5 g and 330 g, preferably between 0.5 g and 40 g, even more preferably between 4 g and 40 g.

In particular, the kit of attractants according to the invention comprises an amount by weight of ethanol of between 0.1 and 300 g, preferably between 0.5 g and 80 g, even more preferably between 1 g and 10 g.

In particular, the kit of attractants according to the invention comprises an amount by weight of methanol of between 0.1 g and 300 g, preferably between 0.5 g and 250 g, even more preferably between 3 g and 30 g.

In one embodiment, the kit of attractants according to the invention comprises an amount by weight of limonene of between 0.1 g and 12 g, preferably between 0.1 g and 3 g, even more preferably between 0.2 g and 1 g.

In one embodiment, the kit of attractants according to the invention comprises an amount by weight of 2-ethyl-1-hexanol of between 0.01 g and 30 g, preferably between 0.1 g and 10 g, even more preferably between 0.2 g and 1 g.

In one particular embodiment, the kit of attractants according to the invention comprises an amount by weight of additional attracting molecule(s) of between 0 and 12 g, preferably between 0 and 6 g, even more preferably between 0 and 2 g.

In another particular embodiment, the kit of attractants according to the invention comprises an amount by weight of diluent of between 0 and 100 g, preferably between 0.5 and 50 g, even more preferably between 0.5 and 5 g.

According to one embodiment, the kit of attractants according to the invention comprises a proportion of the ethanol/methanol mixture of between 15 and 99.98% by weight, preferably between 30 and 99.75%, even more preferably between 75 and 99%.

In one particular embodiment, the kit of attractants according to the invention comprises a proportion of (−)-limonene of between 0.02 and 50% by weight, preferably between 0.2 and 25%, even more preferably between 2% and 10%.

In one particular embodiment, the kit of attractants according to the invention comprises a proportion of 2-ethyl-1-hexanol of between 0.01 and 50% by weight, preferably between 0.1 and 25%, even more preferably between 1% and 10%.

In one particular embodiment, the kit of attractants according to the invention comprises a proportion of diluent of between 0 and 90% by weight, preferably between 0 and 50%, even more preferably between 10 and 25%.

In one particular embodiment, the kit of attractants according to the invention comprises a proportion of additional attracting molecule(s) of between 0 and 50% by weight, preferably between 0 and 25%.

The percentages are given herein relative to the total weight of the components of the kit (other than the diffuser).

According to one embodiment, the kit of attractants according to the invention comprises an ethanol/methanol volume ratio of between 1:10 and 10:1, preferably between 1:10 and 1:1, even more preferably between 1:3 and 1:1.

In one particular embodiment, the kit of attractants according to the invention comprises a (−)-limonene/ethanol/methanol mixture volume ratio of between 5:1 and 1:500, preferably between 1:1 and 1:100, even more preferably between 1:2 and 1:15.

In one particular embodiment, the kit of attractants according to the invention comprises a 2-ethyl-1-hexanol/ethanol/methanol mixture volume ratio of between 10:1 and 1:1000, preferably between 2:1 and 1:500, even more preferably between 1:1 and 1:50.

In one particular embodiment, the kit of attractants according to the invention comprises a (−)-limonene and/or 2-ethylhexanol/additional attracting molecule(s) volume ratio which is greater than 1:2, for example 1:1, 2:1 or 10:1.

In one particular embodiment, the kit of attractants according to the invention comprises a diluent/attractants volume ratio which is less than 9:1 (for example 8:1, 7:1, etc.), the attractants being the ethanol/methanol mixture, the (−)-limonene and/or the 2-ethylhexanol and optionally additional attracting molecule(s).

The kit of attractants according to the invention may comprise the ethanol/methanol mixture, the (−)-limonene and/or the 2-ethylhexanol, optionally the additional attracting molecule(s), optionally the diluent, according to the amounts by weight (expressed in g) detailed above, and/or according to the proportions (expressed as %) detailed above, and/or according to the ratios (by volume) detailed above.

### Dispensing of the Attractants

In one preferred embodiment, said kit of attractants comprises a device which makes it possible to dispense the attractants in the environment. In one preferred embodiment, said kit of attractants comprises one or more diffusers. The term “diffuser” is intended to mean any device allowing the diffusion of the compounds of said kit of attractants. The term “diffusion” is intended to mean the propagation in the environment of the compounds of the kit of attractants according to the invention. Preferably, said diffusion is sufficient to enable the attraction of said coffee berry borer. More particularly, said diffusion corresponds to the evaporation of the compounds of the kit of attractants according to the invention, preferably the evaporation of the attractants of the kit of attractants, the attractants of the kit of attractants being the ethanol/methanol mixture, the (−)-limonene and/or the 2-ethylhexanol and optionally the additional attracting molecule(s). The attractants of the kit according to the invention are not necessarily mixed together in the diffusers, the aim being to create a mixture in the environment, preferentially in the air, after diffusion of each attractant collectively. According to one particular embodiment, the minimum diffusion time is 10 days, preferably the minimum diffusion time is 2 months.

More particularly, different diffusion rates between the attractants of said kit can justify the use of several diffusers. Those skilled in the art are able to determine the content of the diffuser(s) as a function of said desired attractant diffusion rates.

Thus, the diffuser may comprise a single type of attractant, or any mixture of attractants, the attractants being the ethanol/methanol mixture, the (−)-limonene and/or the 2-ethylhexanol and optionally the additional attracting molecule(s). Optionally, the diffuser may contain a diluent, which can act as a diffusion matrix for the attractants of the kit, preferably a mineral oil or paraffin.

According to a first particular embodiment, said kit of attractants comprises:
a diffuser comprising all of the attractants used, that is to say the ethanol/methanol mixture, the (−)-limonene and/or the 2-ethylhexanol, and optionally a diluent.

In this context, the present invention also relates to a composition attractive to the coffee berry borer Hypothenemus hampei, characterized in that it comprises a mixture of ethanol/methanol, (−)-limonene and/or 2-ethylhexanol and optionally a diluent. Preferably, said attracting composition comprises a mixture of ethanol/methanol, (−)-limonene and/or 2-ethylhexanol and optionally a diluent with the component amount and/or proportion and/or ratio characteristics detailed for the kit of attractants above.

According to a second particular embodiment, said kit of attractants comprises two diffusers:
a first diffuser comprising the ethanol/methanol mixture, optionally the 2-ethylhexanol and/or a diluent,
a second diffuser comprising the (−)-limonene, optionally the 2-ethylhexanol and/or a diluent.

According to this embodiment, the two diffusers comprise the attractants and optionally the diluent according to the amounts and/or proportions and/or ratios detailed above.

According to another particular embodiment, the kit of attractants comprises two diffusers:
a first diffuser comprising the ethanol/methanol mixture and optionally the (−)-limonene and/or a diluent,
a second diffuser comprising the 2-ethylhexanol and optionally the (−)-limonene and/or a diluent.

According to this embodiment, the two diffusers comprise the attractants and optionally the diluent according to the amounts and/or proportions and/or ratios detailed above.

According to yet another particular embodiment, said kit of attractants comprises more than two diffusers:
a first diffuser comprising the ethanol/methanol mixture and optionally a diluent,
a second diffuser comprising the (−)-limonene and optionally a diluent,
a third diffuser comprising the 2-ethylhexanol and optionally a diluent.

In each of the above embodiments comprising two or more diffusers, it is also possible to provide for the ethanol and methanol, instead of being included in the same diffuser, being present in two adjacent diffusers (for example in the first and the second diffuser or in the second and the third diffuser), one of which contains the methanol and the other of which contains the ethanol.

Additional attracting molecules, chosen from the abovementioned list, can be added to one or more of the various abovementioned diffusers or can be included in one or more additional diffuser(s).

According to this embodiment, said diffusers comprise the attractants and optionally the diluent according to the amounts and/or proportions and/or ratios detailed above.

In one particular embodiment, the attractants of the kit and/or the diluent as described above may be in solid or liquid form, preferably in liquid form.

In one particular embodiment, said diffuser is a vessel containing the attractant(s) and optionally the diluent, as described above. More particularly, said diffuser is a vessel containing a volume of attractants and optionally of diluent of between 0.1 and 100 ml, preferably between 1 and 20 ml, preferably between 1 and 10 ml.

### Device Comprising the Kit of Attractants

The present invention also relates to a device comprising the kit of attractants as described above. The device comprises for example said diffuser(s) as described above intended to attract the borer into a site of attraction, and/or to modify the behavior thereof or the orientation thereof. The kit of attractants may for example be used in combination with pheromones and/or kairomones.

In one particular embodiment, the device comprising the kit of attractants according to the invention also comprises an element capable of killing and/or of affecting the borer population. For example, it may comprise a wetting agent, an insecticide or a pathogen for the borer, such as Beauveria bassiana.

In another particular embodiment, the device comprising the kit of attractants according to the invention also comprises an element capable of trapping said borer. For example, the element capable of trapping said borer is an element which makes it possible to sequester said borer, in order to prevent it from developing in its initial environment. In one particular embodiment, the element capable of trapping said borer is a vessel. Said vessel capable of trapping said borer comprises openings, allowing said borer to enter, the openings possibly being perforations of variable diameters. More preferentially, said vessel capable of trapping said borer comprises openings of which the shape allows said borer to penetrate into said vessel, and prevents it from leaving again. In one particular embodiment, the vessel also contains a capture substance. For example, said vessel may contain a capture liquid in which said borer drowns. In one preferred embodiment, said capture liquid is a solution of wetting agent of detergent type, such as TFD4. According to one preferred embodiment, said diffuser(s) as described above are placed in the vessel capable of trapping said borer; preferably, said diffuser(s) are attached halfway up in the vessel, preferably suspended halfway up in the vessel.

In one preferred embodiment, said element capable of trapping said borer is a Brocap, Unitrap, Multipher III or Lindgren commercial trap. More particularly, said element is a Unitrap or Lindgren trap.

### Methods and Uses

According to another aspect, the present invention also relates to the use of the kit of attractants as described above, for attracting the coffee berry borer Hypothenemus hampei. According to another aspect, the present invention also relates to a method for attracting the coffee berry borer Hypothenemus hampei, in which said kit of attractants is placed in or in proximity to a site of attraction.

Thus, the use of said kit of attractants and the method of attraction can be carried out in order to manipulate the behavior of the borers. The kit of attractants can in particular be used to create confusion among the coffee berry borers, in such a way that they are no longer capable of locating their host, namely the coffee beans or cherries. According to one particular embodiment, the arrangement of several kits of attractants, more particularly of several diffusers of said kit of attractants according to the invention, in and/or outside the coffee crops, can make it possible to disrupt the borer's recognition with respect to the natural attractants emitted by coffee beans.

The use of said kit of attractants and the method of attraction can also be carried out for biocontrol of the borer populations. More particularly, the kit of attractants can be used to kill the borer or to infect it by means of a pathogen. In one preferred embodiment, the kit of attractants is included in a device which also comprises a wetting agent or an insecticide which makes it possible to kill said attracted borers, or a pathogen such as Beauveria bassiana which makes it possible to affect the borer population.

According to one preferred embodiment, the use for attracting the coffee berry borer and the method of attraction are carried out for trapping said borer. According to one particular embodiment, said kit of attractants is included in a device which also comprises an element capable of trapping said borer. Said device is placed in proximity to a coffee crop. Preferably, said device is placed in the coffee crop. Even more preferably, said device is placed directly in the coffee trees. Preferably, said device is suspended from the branches of the coffee trees, preferably at a height of approximately 1 m 20 or as high as possible when the coffee trees are smaller than 1 m 20.

The term “trapping” is intended to mean the sequestration of said coffee berry borer, preventing it from developing in its initial environment. More particularly, the attraction for trapping said borer is implemented for preserving the coffee tree crops. Said coffee tree crops may be anywhere in the world. More particularly, said coffee tree crops may be of any species or of any variety of coffee which is grown.

Preferably, the trapping of the coffee berry borer is carried out at the beginning of coffee tree fruit formation. It has in fact been observed that the mass trapping obtained by means of the (−)-limonene-based kits is all the more effective when the maturing of the fruits is less advanced. It has moreover been demonstrated that the effectiveness of the kits can be maintained, including during the maturing of the fruits, when 2-ethylhexanol is added to the kit, either in the same diffuser as the (−)-limonene, or in a separate diffuser.

### EXAMPLES

### Example 1: Field Trials in Brazil

### Materials and Methods:

The trapping trials were carried out between Jan. 8 and Mar. 31, 2016, during the fruit maturation phase, in an arabica coffee plantation conducted under biodynamic conditions in the municipality of São João da Boa Vista, in the State of São Paulo in Brazil, at an altitude of 800 m. For each test, three plots received trials, each representing a random complete block.

The Coffea arabica var. tupi plantations were set up at the beginning of the 2000s in combination with shade trees (Acacia mangium, Acacia auriculiformis, Gliricidia sepium, Leucaena leucocephala). The rows are oriented along the contour lines with a variable spacing according to the plots (0.6 to 0.75×3 to 3.6 meters), and the shade trees are planted at regular intervals in the rows of coffee trees. All of the plots benefit from considerable annual maintenance: regular cutting between the rows, organic fertilization and weeding during fruit formation, foliar fertilization during bean swelling and maturation. The yields therefrom are however moderate, about 600 to 800 kg/ha/year.

The traps (Pherobank Unitrap wing model) were placed directly in the coffee trees, suspended from the branches at a height of 1.20 meters or as high as possible when the plants were smaller. The spacing between the traps is approximately 20 meters.

The products used were supplied by Sigma-Aldrich. They are:

Ethanol puriss. p.a., ≥99.8%, CAS No.: 64-17-5

Methanol Chromasolv®≥99.9%, CAS No.: 67-56-1

(S)-(−)-Limonene >95%, FCC,FG, CAS No.: 5989-54-8

(R)-(+)-Limonene 97%, CAS No.: 5989-27-5

Liquid paraffin, puriss., CAS No.: 8012-95-1

The products were placed in 2 ml glass vials, in which the opening of the septum allows free diffusion by evaporation. A first diffuser contained 0.5 ml of ethanol and 0.5 ml of methanol. A second diffuser contained, where appropriate, the terpenoids diluted in paraffin (0.5 ml of (−)-limonene or 0.5 ml of (+)-limonene, 0.5 ml of paraffin and where appropriate 0.1 ml of (−)-α-pinene).

The number of coffee berry borers trapped was recorded daily, and the modes tested were modified each week which represents a test. Each recording in each block represents a repetition. Between each test, the traps were washed with a 2% TFD4 solution and the diffusers were changed.

### Results:

Study of the Attractiveness of the (−)-Limonene Combined with the Ethanol/Methanol Mixture to the Coffee Berry Borers

TABLE 1
Number of coffee berry borers trapped on the three plots tested
(sum of the blocks), at the end of one week of tests and according
to 3 modes: an empty diffuser (control 0); a diffuser comprising
the ethanol/methanol mixture (E + M); a diffuser comprising
the ethanol/methanol mixture combined with a diffuser comprising
the (−)-limonene (E + M + (−)-limonene).

| Mode | Number of borers trapped |
|---|---|
| Control 0 | 0 |
| E + M | 4 |
| E + M + (−)-limonene | 26 |

Table 1 demonstrates that, at the end of a test (that is to say one week), the sum of the Hypothenemus hampei that were trapped on the 3 plots tested is clearly increased when combining the (−)-limonene with the ethanol/methanol mixture compared with the ethanol/methanol mixture alone.

This result is confirmed by table 2 which represents the total number of Hypothenemus hampei trapped for 3 weeks of tests (sum of the 3 tests):

TABLE 2
Number of coffee berry borers trapped on the three plots tested
(sum of the blocks), over the course of 3 weeks of tests (sum
of the 3 tests) and according to 2 modes: a diffuser comprising
the ethanol/methanol mixture (E + M); a diffuser comprising
the ethanol/methanol mixture combined with a diffuser comprising
the (−)-limonene (E + M + (−)-limonene).

| Mode | Number of borers trapped |
|---|---|
| E + M | 29 |
| E + M + (−)-limonene | 58 |

Table 2 confirms that the addition of the (−)-limonene improves the attractiveness of the ethanol/methanol mixture. Indeed, the average number of Hypothenemus hampei trapped on the 3 plots at the end of the 3 tests is much higher when limonene is added to the ethanol/methanol mixture, compared with the alcohols alone.

### Comparison of the (+) and (−) Enantiomers of Limonene

The inventors have demonstrated that the attractiveness of the ethanol/methanol mixture was improved only with the (−) enantiomer of limonene. Indeed, the (+) enantiomer of limonene does not increase the number of borers trapped when it is combined with the ethanol/methanol mixture, compared with the alcohols alone (cf. table 3 below).

TABLE 3
Number of borers trapped on the three plots tested (sum of the
blocks), over the course of two weeks of tests (sum of the two
tests), and according to 4 modes: an empty diffuser (control 0);
a diffuser comprising the ethanol/methanol mixture (E + M);
a diffuser comprising the ethanol/methanol mixture combined with
a diffuser comprising the (−)-limonene (E + M + (−)-limonene);
a diffuser comprising the ethanol/methanol mixture combined with
a diffuser comprising the (+)-limonene (E + M + (+)-limonene).

| Mode | Number of borers trapped |
|---|---|
| Control 0 | 0 |
| E + M | 51 |
| E + M + (+)-limonene | 30 |
| E + M + (−)-limonene | 80 |

### Comparative Trial

A comparative trial was carried out by replacing the (−)-limonene with another volatile constituent of coffee cherries, linalool, which is emitted in a high proportion in the coffee aromas. The results of this trial are collated in table 4 below.

TABLE 4
Number of borers trapped on the three plots tested (sum of
the blocks), over the course of one week of tests and according
to 3 modes: an empty diffuser (control 0); a diffuser comprising
the ethanol/methanol mixture (E + M); a diffuser comprising
the ethanol/methanol mixture combined with a diffuser comprising
natural linalool (E + M + linalool).

| Mode | Number of borers trapped |
|---|---|
| Control 0 | 0 |
| E + M | 21 |
| E + M + linalool | 3 |

### Discussion

As could be expected, the controls without attractants almost never trapped the borers. The traps are not therefore attractive for the borers without attractant diffusers and the borer population density is sufficiently low for the captures not to be due to chance.

On all of the tests, the addition of (−)-limonene to the ethanol/methanol mixture significantly increased the number of borers trapped per trap and per day compared with the alcohols alone. The (+)-limonene did not make it possible to improve the captures compared with the alcohol mixture alone. In addition, the attracting effect of the ethanol/methanol mixture virtually disappears in the presence of linalool.

### Example 2: Field Trials in Costa Rica

### Materials and Methods:

The trials carried out above were supplemented in 2017 in Costa Rica, in a context of larger coffee berry borer populations.

The trapping trials were carried out between Feb. 21 and Apr. 27, 2017, in the commercial arabica coffee plantations of the CATIE (Centro Agronómico Tropical de Investigación y Enseñanza) [The Tropical Agricultural Research and Higher Education Center] in Turrialba, Costa Rica. The number of repetitions per treatment varied from 6 to 9 depending on the trials, the blocks having been formed so as to be as uniform as possible.

The Coffea arabica var. caturra plantations, located at approximately 600 meters of altitude, were planted in 2010 in combination with Erythrina poeppigiana as shade trees. The rows are oriented along the contour lines with a spacing of 80 cm between the plants and 2 meters between the rows (6300 plants/ha). All of the plots benefit from considerable annual maintenance: pluriannual weeding or chemical weed-killing between the rows, chemical fertilization during fruit formation, fungicide and optionally insecticide treatments in the event of coffee berry borer infestation. The yields therefrom are medium, about 1000 kg/ha/year of green bean coffee.

Brocap® traps were placed directly in the coffee trees, suspended from the branches at a height of approximately 1 meter and with a spacing between the traps of approximately 20 meters.

The attractants tested are the following:

Ethanol and methanol mixture: attractant sold by Icafé (Instituto del café de Costa Rica) [Coffee Institute of Costa Rica], packaged in 15 ml diffuser bottles, ethanol/methanol ratio 1:3.

(S)-(−)-Limonene >95% FG, Sigma-Aldrich, CAS No.: 5989-54-8

2-Ethyl-1-hexanol (racemic), Sigma-Aldrich, CAS No.: 104-76-7

Liquid paraffin, puriss., Sigma-Aldrich, CAS No.: 8012-95-1

When all the products were diffused as mixtures, the alcohols and the additional attractant compounds were placed in 4 ml vials, the PTFE septum of which was perforated with a hole 1/16″ in diameter (approximately 1.58 mm) allowing free diffusion by evaporation. When the alcohols were diffused separately, a 2 or 4 ml vial with a perforated septum, containing the terpenoids diluted in the paraffin, was combined with the commercial diffuser of alcohols.

The number of coffee berry borers trapped was recorded daily. Each recording in each block represents a repetition. Between each test, the traps were washed with a 2% TFD4 solution and the diffusers were changed.

### Results:

Confirmation of the Advantage of (−)-Limonene Combined with the Ethanol/Methanol Mixture:

TABLE 5
Number of coffee berry borers trapped over all of the repetitions
(9 traps per treatment, 2 recordings per trap), at the end
of 3 days of tests and according to 3 modes: an empty diffuser
(control 0); a diffuser comprising the ethanol/methanol commercial
attractant mixture (E + M); a diffuser comprising the
ethanol/methanol mixture combined with a diffuser comprising
the (−)-limonene (E+M and (−)-limonene).

| Mode | Number of borers trapped |
|---|---|
| Control 0 | 4 |
| E + M | 554 |
| E + M and (−)-limonene | 1003 |

Table 5 demonstrates that the sum of the Hypothenemus hampei trapped over the 9 randomized repetitions is clearly increased by combining (−)-limonene with the ethanol/methanol mixture compared with the ethanol/methanol mixture alone.

Advantage of 2-Ethyl-1-Hexanol Combined with the Ethanol/Methanol Mixture:

TABLE 6
Number of coffee berry borers trapped over all of the repetitions
(6 traps per treatment, 3 recordings per trap), at the end of
4 days of tests and according to 3 modes: an empty diffuser
(control 0); a diffuser comprising the ethanol/methanol commercial
attractant mixture (E + M); a diffuser comprising the ethanol/methanol
mixture combined with a diffuser comprising the 2-ethyl-1-hexanol
(E + M and 2-ethyl-1-hexanol).

| Mode | Number of borers trapped |
|---|---|
| Control 0 | 4 |
| E + M | 170 |
| E + M and 2-ethyl-1-hexanol | 403 |

Table 6 demonstrates that the sum of the Hypothenemus hampei trapped is clearly increased by combining 2-ethyl-1-hexanol with the ethanol/methanol mixture compared with the ethanol/methanol mixture alone.

### Possibility of Mixing the Components of the Attractant Kit:

TABLE 7
Number of coffee berry borers trapped over all of the repetitions
(6 traps per treatment, 3 recordings per trap), at the end of
4 days of tests and according to 6 modes: an empty diffuser (control
0); a diffuser comprising the ethanol/methanol commercial attractant
mixture (E + M); a diffuser comprising the ethanol/methanol
commercial attractant mixture and (−)-limonene (E + M +
(−)-limonene); a diffuser comprising the ethanol/methanol
commercial attractant mixture and 2-ethyl-1-hexanol (E +
M + 2-ethyl-1-hexanol); a diffuser comprising the ethanol/methanol
commercial attractant mixture, (−)-limonene and 2-ethyl-1-
hexanol (E + M + (−)-limonene + 2-ethyl-1-hexanol).

| Mode | Number of borers trapped |
|---|---|
| Control 0 | 0 |
| E + M | 55 |
| E + M + (−)-limonene | 98 |
| E + M + 2-ethyl-1-hexanol | 103 |
| E + M + (−)-limonene + | 184 |
| 2-ethyl-1-hexanol | |

Table 7 demonstrates that the number of Hypothenemus hampei trapped is clearly increased by mixing (−)-limonene with the ethanol/methanol mixture compared with the ethanol/methanol mixture alone. The mixing of 2-ethyl-1-hexanol with the alcohols also makes it possible to increase the trappings compared with the ethanol/methanol mixture. This increase is even greater when the 2 compounds, (−)-limonene and 2-ethyl-1-hexanol, are added to the ethanol/methanol mixture.

1-10. (canceled)

11. A kit of attractants for attracting the coffee berry borer Hypothenemus hampei, which comprises a mixture of ethanol/methanol and (−)-limonene, or 2-ethylhexanol or a mixture thereof.

12. The kit of attractants as claimed in claim 11, which further comprises a diluent.

13. The kit of attractants as claimed in claim 12, wherein the diluent is paraffin or a mineral oil.

14. The kit of attractants as claimed in claim 11, which comprises one or more diffusers.

15. The kit of attractants as claimed in claim 14, which comprises a first diffuser comprising the ethanol/methanol mixture, a second diffuser comprising (−)-limonene and optionally a diluent and optionally a third diffuser comprising 2-ethylhexanol and optionally a diluent.

16. The kit of attractants as claimed in claim 14, which comprises two diffusers:
a first diffuser comprising the ethanol/methanol mixture and optionally 2-ethylhexanol, a diluent or a mixture thereof, and
a second diffuser comprising (−)-limonene and optionally 2-ethylhexanol, a diluent or a mixture thereof.

17. The kit of attractants as claimed in claim 14, which comprises two diffusers:
a first diffuser comprising the ethanol/methanol mixture and optionally (−)-limonene, a diluent or a mixture thereof, and
a second diffuser comprising 2-ethylhexanol and optionally (−)-limonene, a diluent or a mixture thereof.

18. The kit of attractants as claimed in claim 14, which comprises a diffuser comprising:
the ethanol/methanol mixture,
(−)-limonene, 2-ethylhexanol or a mixture thereof, and
optionally a diluent.

19. A device comprising the kit of attractants as claimed in claim 11, said device being capable of trapping and/or killing said borer.

20. A method for attracting the coffee berry borer Hypothenemus hampei, wherein the kit of attractants as claimed in claim 1 is placed in or in proximity to a site of attraction.

21. The method of claim 20 which is intended for trapping and/or killing said borer or for modifying the behavior of said borer.

22. A method for attracting the coffee berry borer Hypothenemus hampei, wherein the device as claimed in claim 19 is placed in or in proximity to a site of attraction.

23. The method of claim 22 which is intended for trapping and/or killing said borer or for modifying the behavior of said borer.
